(19) United States
(12) Patent Application Publication
(10) Pub. No.: US 2007/0005495 A1
(43) Pub. Date: Jan. 4, 2007

(54) Electronic commerce sytem and method using the electronic approval infromation

(76) Inventor: Jae Heun Kim, INCHEON (KR)

Correspondence Address: John W. Renner;Renner, Otto, Boisell &Sklar, 1621 Ecluclide Avenue, 19th Floor, Cleveland, OH, 44115, US

(21) Appl. No.: 10/539,794

(22) PCT Filed: Dec. 18, 2003
(86) PCT No.: PCT/KR03/02767

§ 371 Date: May 18, 2006

(30) Foreign Application Priority Data
Dec. 18, 2002 (KR) 10-2002-0081419

(51) Int. Cl. G06Q 30/00; G06Q 40/00

(52) U.S. Cl. 705/40; 705/26

(57) ABSTRACT

The present invention relates to electronic commerce system and method using the electronic approval information. An electronic commerce is achieved between a purchase unit of a purchaser and a sale unit of a seller on the network. In an electronic commerce system using an electronic approval information achieved in such a manner that an electric commerce is achieved between a purchase unit of a purchaser and a sale unit of a seller on the network, there are provided a purchase unit 100 in which a purchaser receives a selling product and a service information and purchases a corresponding product or service; a produce sale unit 200 in which a product or service having an electronic approval recognition code information of a product code and a product model of a product sold on the network (NT) is sold; a home shopping unit 300.

### TECHNICAL FIELD

The present invention relates to an electronic commerce system and a method of the same, and in particular to an electronic commerce system and a method of the same using an electronic payment (approval) information inserted into a product or an advertisement in such a manner that an electronically processed payment information is inserted into a product information of each product, so that a customer can easily shop using a wired or wireless communication apparatus, while seeing a product or an advertisement with an electronic payment information.

### BACKGROUND ART

Generally, in the electronic commerce (EC), when a customer is connected with an internet network using a communication apparatus, the information of products are listed in an electronic commerce site on the internet. When a customer selects certain product information, the information of the selected product is provided, so that the customer can check the product. Thereafter, when the customer requests an electronic payment approval (credit card or automatic transfer) to the customer, the payment is completed, and the product is delivered to the customer.

However, in the above-described electronic commerce method, the advertisement or product has only a price, telephone number, product name, product introduction, etc. Any payment information is not provided therein. Therefore, in this case, the customer must buy the product in an offline shop or the customer buys the product through several steps using a wired or wireless Internet. Namely, as a product confirmation is needed through product image information, a work for making an image file with respect to each product and a work for downloading the image file of the product into a customer's terminal are needed for thereby completing a purchase or reservation purchase of the product.

In addition, in the home shopping advertisement, telephone number information is provided in the advertisement, but purchase information and a payment method should be produced to the customer by a consultant or through an ARS using a wired or wireless telephone.

In the case of the TV advertisement, it has only an image or common information with respect to the product, the customer should visit a shop or a web site of a corresponding company in order to buy a corresponding product. In this case, it is more difficult to buy the product as compared to the home shopping method.

Therefore, in the above-described home shopping advertisement or TV advertisement, the electronic commerce method requires more time and higher cost.

### DISCLOSURE OF INVENTION

Accordingly, it is an object of the present invention to provide an electronic commerce system and a method of the same capable of overcoming the problems encountered in the conventional art.

It is another object of the present invention to provide an electronic commerce system and a method of the same capable of achieving an electronic commerce between a purchaser and a seller, so that a customer buys a product using an information recognition code at the time when a customer feels a purchase in such a manner that an electronically payable product code and an electronic payment recognition code information of a product model are inserted into an advertisement or a product.

To achieve the above objects, there is provided an electronic commerce system using an electronic payment information in which a commercial transaction is achieved between a purchase unit of a purchaser and a sale unit of a seller on the network, comprising a purchase means 100 in which a purchaser receives a selling product and service information and purchases a corresponding product or service; a product sale unit 200 in which a product or a service having an electronic payment recognition code information of a product code and a product model sold on the network NT is sold; a home shopping unit 300 connected with the network NT in such a manner that a direct commerce transaction is achieved between the purchase unit 100 and the product sale unit 200; a newspaper or TV advertisement unit 400; a financial payment proxy organ 500 connected through the network NT in such a manner that a payment is achieved between the home shopping unit 300 or the newspaper or TV advertisement unit 400 and the purchase unit 100; and a delivery company 600 for delivering the products.

To achieve the above objects, there is provided an electronic commerce method using an electronic payment information in which a commercial transaction is performed between a purchase unit of a purchaser and a product sale unit of a seller on the network, comprising a step S32 for connecting a purchase unit 100 to the network for issuing/registering/managing an electronic payment recognition code information of a product code and a product model using an electronic payment information of a product or an advertisement; a step S34 in which when a purchaser selects an electronic payment recognition code information of a product code and a product model that a customer wants to purchase from a product group list advertised in a home shopping unit 300 or a newspaper advertisement and TV advertisement unit 400, the product sale managing server 214 provided a product model recognition code list of the products that the purchaser selected, to the purchaser, and the electronic payment server 216 provides an electronic payment information to the product or the advertisement; a step S36 in which an electronic purchase is requested using an electronic payment information service of the product sale unit 200 that prepared the products and advertisements in the electronic payment information providing step S34; a step S38 in which the electronic payment server 216 that performed the electronic purchase request step S36, approves a corresponding payment content confirmation and a user approval for thereby approving a payment; and a step S40 in which the product is delivered in the case that there is not any error in the user approval and payment approval step S364.

### BRIEF DESCRIPTION OF THE DRAWINGS

The present invention will become better understood with reference to the accompanying drawings which are given only by way of illustration and thus are not limitative of the present invention, wherein;

FIG. 1 is a view illustrating an electronic commerce system using a product model recognition code according to the present invention;

FIG. 2 is a block diagram of a product sale unit capable of managing a stock status by products in real time according to the present invention; and

FIG. 3 is a flow chart of an electronic commerce system using a product model recognition code according to the present invention.

### BEST MODE FOR CARRYING OUT THE INVENTION

The preferred embodiments of the present invention will be described with reference to the accompanying drawings.

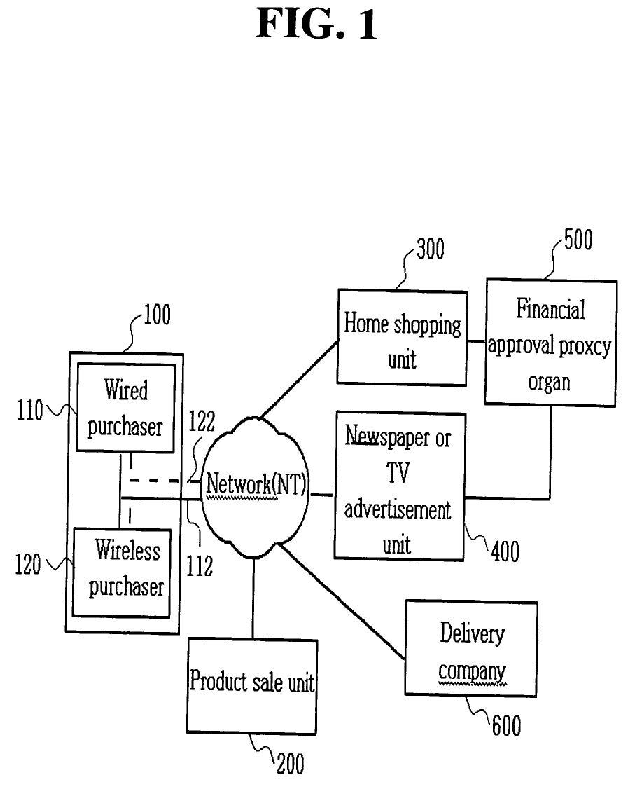

FIG. 1 is a block diagram of an electronic commerce system using a product model recognition code according to the present invention.

As shown in FIG. 1, the electronic commerce unit using a product model recognition code according to the present invention includes a purchase unit 100 for purchasing a product or a service information, a product sale unit 200 for selling a product or service through a network (NT), a home shopping unit 300 directly connected with the network for achieving an electronic commerce, a newspaper or TV advertisement unit 400, a financial payment proxy organ 500 for achieving a payment between the home shopping unit 300 or the newspaper or TV advertisement unit 400 and the purchase unit 100, and a delivery company 600.

The purchase unit 100 uses a communication apparatus capable of directly accessing the home shopping unit 300 and the newspaper or TV advertisement unit 400 through the network NT. Here, it may be formed of a computer or other apparatuses such as an Internet based TV without limiting to a mobile communication terminal that is a wireless Internet 122 or a wired telephone 122. Namely, the purchase unit 100 can be connected with the home shopping unit 300 or the TV shopping 400 through the wired Internet 112 or can be connected with the home shopping unit 300 or the TV shopping 400 through the wireless communication network 122.

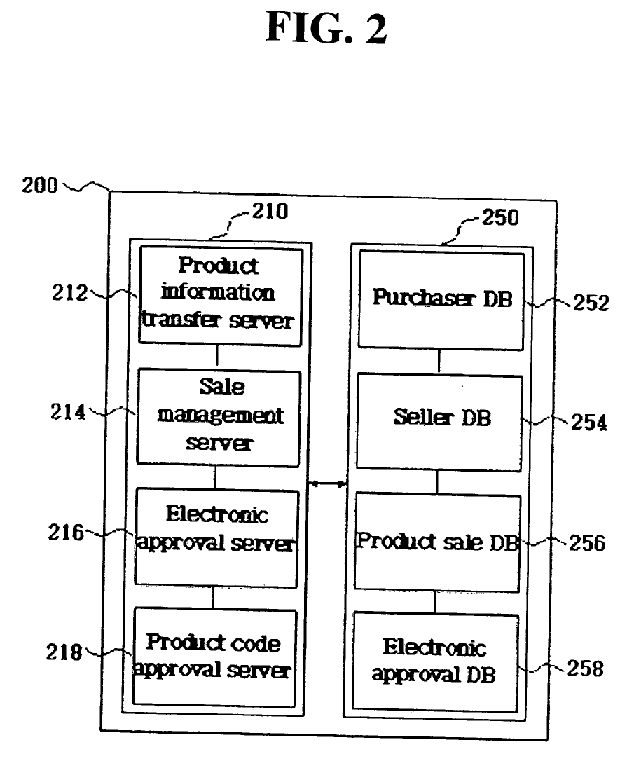

In addition, the product sale unit 200 is a certain apparatus operated by a sale person who sells various products and services for thereby achieving an electronic commerce on the network NT by connecting the purchase unit 100 connected through the mobile communication service-based wireless communication network 122 through the network NT. FIG. 2 shows the inner structure of the sale unit. In the preferred embodiment of the present invention, the purchaser can charge the prices of the purchaser's products by including it into the mobile phone charges without cooperation with the home shopping unit 300 or the TV shopping 400.

In the home shopping unit 300, the payment is directly performed through a user's approval from the financial payment proxy organ 500 in such a manner that the purchaser can pay using the electronic payment information indicated in the item advertisement without using the consultant or the ARS.

In the TV shopping 400, the payment is directly performed through the user's approval from the financial payment proxy organ 500 while the customer is watching the TV advertisement.

The delivery company 600 delivers the purchased products based on the contents of the order in cooperation with the product sale unit 200 or the conventional on/offline shops with respect to the order of the product purchaser.

FIG. 2 is a block diagram of the product sale unit 200 capable of managing the product-based stock status in real time according to the present invention.

As shown therein, the product sale unit 200 of the electronic commerce system according to the present invention includes a product sale unit 210, and a product information database (DB) 250 capable of managing the database of the product information. The product sale unit 210 is connected with the product information DB 250, and the product information provided from the product information providing server 212 that sale the products of the product sale unit 210 in wholesale or retail sale are stored in the product information DB 250 by the sale managing server 214.

Corresponding information of the product is stored in the product information DB 250. In addition, as information with respect to each product sale unit 210, a purchaser DB 252, a seller DB 254, a product sale DB 256, and an electronic payment DB 258 are connected, respectively.

In the product sale unit 210, the product information providing server 212 is capable of managing the input and output of the information stored in the product stock managing server 216.

The sale managing server 214 receives a product code of the product that is to be sold, a payment code of the product model, and the information of the purchaser from the product sale unit 210, so that the product is delivered to the purchaser for thereby managing the sale status of each product. In addition, the sale managing server 214 provides all functions so that the purchaser is connected through the purchase unit 100 and registers his information to the seller DB 254 for thereby performing product purchase, etc.

The electronic payment server 216 is connected with the sale managing server 214 of the product sale unit 210, and the product of the sale managing server 214, the product code, the payment code of the product model and the information status of the purchaser are stored in the electronic payment DB 258 of the product information DB 250 for thereby updating the sale or payment status.

In addition, the product code approval server 218 of the product sale unit 210 is connected with the electronic payment server and approves the payment information based on the product sold based on the codes of the seller's company requested from the seller DB 254. Here, the electronic payment approval code information provided to each sold product includes a sale code, an address code of the seller, a member classification code of the purchaser who purchased the product, a corresponding member name and ID, a sale time at the time when the product is sold, a sale quantity and a sale price.

The product code approval server 218 may be connected with a PDA (Personal digital Assistant), a cellular phone, a computer, a cash stored card with a communication function, a remote controller with a communication function, etc., differently from a special instrument or an equipment like a barcode system.

The electronic payment type recognition code of the product code and product model for the electronic payment information by the products and advertisements can have an inherent system by the companies, and the recognition system capable of indicating the electronic payment information by the products and advertisements includes WINC method that is a newly developed internet-based recognition system as a recognition system for indicating the electronic payment information by the products and advertisements, WILS method, ENUM (Telephone number Mapping) method, URN (Uniform Resource Name) method, etc.

In addition, the product information DB 250 includes product information DB 250, a purchaser DB 252, a seller DB 254, a product sale DB 256, and an electronic payment DB 258. The purchaser DB 252 stores a plurality of information with respect to the purchasers who are registered members capable of receiving a product purchase and information service.

The seller DB 254 stores the information of multiple sellers or product fabrication companies who sell the products on the electronic commerce system. In addition, the URL (Uniform Resource Location) on the Internet of the product sale unit 200 may be stored in the seller DB 254.

The information concerning the product that the seller registered is stored in the product sale DB 256. Namely, the product DB 256 stores the address code by the company code of the seller who requested the sale of the product, a nation code, a product model recognition code allocated to each product, a product name, a dimension, a color, a material, a price of the product, the purpose of use of product.

The electronic payment DB 258 stores payment information of the sale information concerning the sold products and further stores the information concerning the last transmission time of the information transmitted to a corresponding product sale unit 200 with respect to the information of the sold product.

In addition, the electronic payment DB 258 of the products is a database capable of storing an information of the product model recognition code capable of recognizing the products as an electronic payment information, and an electronic payment recognition code information of the product code and product model by classifying the electronic payment recognition code information of the product model. The product information DB 250 is updated by receiving produce sale information transferred from the sale managing server 214 of the product sale unit 210, namely, the product status and the electronic payment information.

When the electronic payment recognition code information of the product code and model of the electronic payment unit are used, it is possible to achieve a low cost purchase because an intermediate transaction procedure is omitted, and a price discount is achieved through the joint purchase unit based on mass purchase. In addition, a mileage service function is achieved based on a point accumulation of the purchase information, so that both customer and manufacturer have profits.

Namely, the applications of the electronic payment unit will be described as follows.

First, when booking a ticket for a public performance, a product code of an electronic payment information and an electronic payment recognition code information of the product model may be indicated in an advertisement for a public performance, so that a booking or cancellation can be easily achieved.

Second, when buying a book or music disk, if a customer knows an electronic payment information indicated on the book, it is possible to receive the book in a desired place through a purchase procedure irrespective of the places.

Third, when buying a common product, if a customer knows an electronic payment information, the customer can easily buy a desired product through a payment as compared to the conventional art in which the product can be bought at a common shop having a barcode apparatus because the information such as barcode and common telephone number that is not related with payment is provided in the current system.

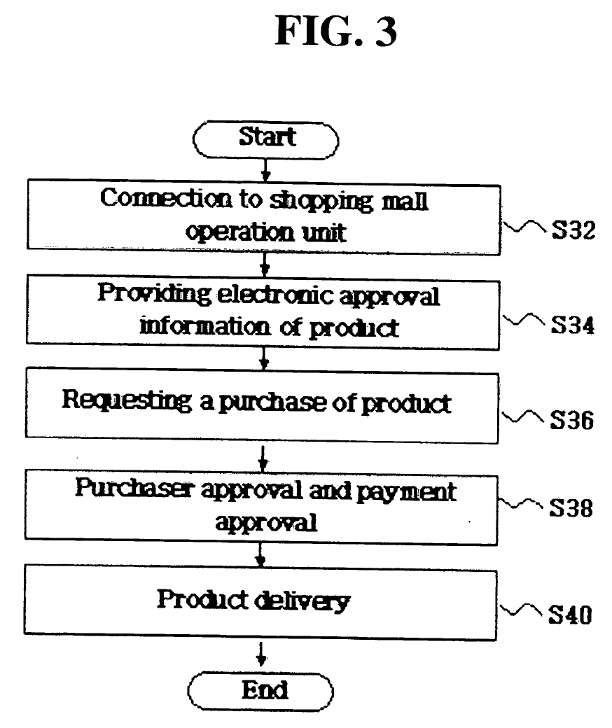

FIG. 3 is a flow chart of an electronic commerce system using a product model recognition code according to a first embodiment of the present invention.

As shown therein, the purchase unit 100, the product sale unit 200, the shopping unit 300 and the TV shopping unit 400 of the electronic commerce are connected with the network each other, so that the product information and product sale information are shared and exchanged in real time. The sale status of each product may be judged by the product sale unit 300, and the electronic payment information may be processed.

First, in the electronic commerce system according to the present invention, the mobile communication terminal is connected with the network terminal in S32 in the purchase unit 100 for issuing/registering/managing the electronic payment recognition code information of the product code and product model using electronic payment information indicated on the product or the advertisement.

Here, the product sale unit 200 registers the electronic payment recognition code information of the product code and product model of the product or advertisement into the electronic payment information server 216 constructed based on a cooperation agreement with the owner of advertisement or manufacturer of the product. In addition, the product sale unit 200 can share the payment information DB 258 based on a cooperation agreement with a user registration organ including a user financial payment proxy organ 500 such as a mobile service provider/credit card company/financial companies. In order to use the electronic payment information stored in the electronic payment information DB 258, a customer may register to the electronic payment information server 216 intentionally or unintentionally. In addition, the purchaser who received the member certification inputs an electronic payment recognition code information of the product name and product code for purchasing a certain product. At this time, the product stock managing server 120 judges the electronic payment recognition code information of the product code and the product model received from the purchase unit 100, searches the memory region allocated to the product sale DB 256, and provides the searched information to the purchaser.

When the purchaser selects the electronic payment recognition code information of the product code and the product model from the product list advertised in the home shopping unit 300 or the newspaper advertisement and TV advertisement unit 400, the product sale managing server 214 provides the product model recognition code list of the products selected by the purchaser to the purchaser, and the electronic payment server 216 provides an electronic payment information to the product or advertisement in Step S34.

Here, in the electronic payment information providing step S34, the manufacturer of the product and advertisement receives an electronic payment information based on the contents registered in the sale managing server 214 of the product sale unit 210 for providing an electronic payment information service (S342). The manufacturer indicates the product model recognition code information from the electronic payment server 216 on the product and advertisement (S344). The sale managing server 214 of the product sale unit 210 updates a corresponding information based on the real-time transmission of the sale status from the product sale DB 256.

Next, the purchaser, who checked the possibility of the purchase of the product in the electronic payment information providing step S34, requests an electronic purchase using electronic payment information in Step S36. Namely, the purchaser who is a customer checks whether there is a desired product recognition code in the product model recognition code list received from the purchase managing DB 250 and checks whether the information that the purchaser knows is correct. Thereafter, the customer selects a product model recognition code of a desired product among the product model recognition code list. Here, in the electronic purchase request step S36, the customer is directly connected with the electronic payment unit using a cellular phone, PDA, computer, communication function remote controller, etc. through the electronic is payment information.

The electronic payment server 216 that performed the procedures of the electronic purchase request step S36 checks a corresponding payment content, performs a user approval procedure (password confirmation), and finally approves the payment (S38). Namely, the electronic payment server 216 searches and judges a purchase product from the product sale DB 256 based on the product model recognition code that the purchaser selected. At this time, the purchaser connected with the product code approval server 218 receives an approval concerning his personal information and the electronic payment recognition code information of the product code and product model. Here, the product sale DB 256 is updated in real time based on the electronic payment recognition code information of the product code and product model sold in the home shopping unit 300 or the TV shopping unit 400. In the case that there is a certain error in the user approval and payment approval step S38, there is provided an error correction step S382 for correcting the above error.

At this time, in the case that there is not an error in the user approval and payment approval step S364, a corresponding product approved by the electronic payment information is delivered (S40).

As the product purchase is requested in the electronic purchase request in Step S36, and a corresponding payment content is confirmed, and the approved payment is performed in Step S38, the electronic payment recognition code information of the product code and product model that are the product purchase request signals are directly transferred to the financial payment proxy organ 600 not through the home shopping unit 300 and the TV shopping unit 400 in the electronic payment server 216. At the same time, when the user approval and payment approval are achieved, the product sale unit 210 is driven, and the product information concerning the purchase product is transferred to the purchaser.

The product sale unit 200 delivers a corresponding product to the purchaser based on the electronic payment recognition code information of the product code and product model from the produce sale unit 210 (S40). Namely, the product sale unit 200 is performed properly with respect to the order in cooperation with the delivery company 600 or the conventional on/offline shop.

In the product purchase through delivery step, a certain price policy such as a joint purchase, free gift event, price discount with respect to cyber cash, etc. may be performed.

### INDUSTRIAL APPLICABILITY

As described above, the purchaser who is a customer using the mobile communication terminal checks the color, design, size, etc. of the advertisement product and pays through a cellular phone using the electronic payment recognition code information of the product code and product model that are the electronic payment information recognition code indicated in the advertisement or product, so that the customer receives an approval through the user approval procedure. Namely, the products may be directly bought by the customer using the electronic payment information, while watching advertisements.

The present invention is not limited to the above embodiment. As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An electronic commerce system using an electronic payment information in which a commercial transaction is achieved between a purchase means of a purchaser and a sale means of a seller on the network, comprising:
a purchase means 100 in which a purchaser receives a selling product and service information and purchases a corresponding product or service;
a product sale means 200 in which a product or a service having an electronic payment recognition code information of a product code and a product model sold on the network NT is sold;
a home shopping means 300 connected with the network NT in such a manner that a direct commerce transaction is achieved between the purchase means 100 and the product sale means 200;
a newspaper or TV advertisement means 400;
a financial payment proxy organ 500 connected through the network NT in such a manner that a payment is achieved between the home shopping means 300 or the newspaper or TV advertisement means 400 and the purchase means 100; and
a delivery company 600 for delivering the products.

2. The system of claim 1, wherein said product sale means 200 includes a product sale unit 210, and a product information DB 250 connected with the product sale unit 210 for managing a database of the product information.

3. The system of claim 1, wherein said product sale unit 210 includes:
a product information providing server 212 for selling the products in wholesale or retail sale;
a sale managing server 214 for receiving a payment code of the product code and product model of the selling products (items) from the product sale unit 210 and an information of the purchaser and managing a sale status of each product so that the product is delivered to the purchaser;
an electronic payment server 216 connected with the sale managing server 214 of the product sale unit 210 for storing a payment code of the product code and product model of the selling products or items of the sale managing server 214 and an information status of the purchaser into the electronic payment DB 258 of the product information DB 250; and
a product code approval server 218 connected with the electronic payment server 218 for approving a payment information based on the products sold by the company codes of a requesting seller from the seller DB 254.

4. The system of claim 1, wherein said product information DB 250 includes a purchaser DB 252, a seller DB 254, a product sale DB 256, and an electronic payment DB 258 as an information with respect to the product sale unit 210.

5. The system of claim 1, wherein said product code approval server 218 includes a PDA (Personal Digital Assistant), a cellular phone, a cash stored card with a communication function, and a remote controller with a communication function.

6. The system of claim 1, wherein said electronic payment approval code information of the product includes a product model recognition code, a sale code provided to each sold product, an address code of a seller, a member classification code of a purchaser who purchased a product, a corresponding member name and ID, a sale time at the time when the product is sold, a quality of products sold, and a sale price.

7. The system of claim 1, wherein said electronic payment recognition code of the product code and product model for the electronic payment information by the products and advertisements includes a WINC method that is an internet recognition system, a WILS method, an ENUM (Telephone Number Mapping), and a URN (Uniform Resource Name) method wherein above methods are provided as an inherent recognition system for each company.

8. The system of claim 1, wherein said product information DB 250 includes a purchaser DB 252, a seller DB 254, a product sale DB 256, and an electronic payment DB 258.

9. An electronic commerce method using an electronic payment information in which a commercial transaction is performed between a purchase means of a purchaser and a product sale means of a seller on the network, comprising:
a step S32 for connecting a purchase means 100 to the network for issuing/registering/managing an electronic payment recognition code information of a product code and a product model using an electronic payment information of a product or an advertisement;
a step S34 in which when a purchaser selects an electronic payment recognition code information of a product code and a product model that a customer wants to purchase from a product group list advertised in a home shopping means 300 or a newspaper advertisement and TV advertisement means 400, the product sale managing server 214 provided a product model recognition code list of the products that the purchaser selected, to the purchaser, and the electronic payment server 216 provides an electronic payment information to the product or the advertisement;
a step S36 in which an electronic purchase is requested using an electronic payment information service of the product sale means 200 that prepared the products and advertisements in the electronic payment information providing step S34;
a step S38 in which the electronic payment server 216 that performed the electronic purchase request step S36, approves a corresponding payment content confirmation and a user approval for thereby approving a payment; and
a step S40 in which the product is delivered in the case that there is not any error in the user approval and payment approval step S364.

10. The method of claim 9, wherein said electronic payment information providing step S34 includes:
a step S342 for receiving an issuance of an electronic payment information based on the contents registered in the sale managing server 214 of the product sale unit 210 so that the manufacturer of the product and the advertisement provides an electronic payment information service; and
a step S344 in which the manufacturer of the product and the advertisement indicates a product model recognition code information from the electronic payment server 216.

11. The method of claim 9, wherein said user approval and payment approval step S38 includes a step S382 for correcting an error when there is an error.
